(19) United States
(12) Patent Application Publication
(10) Pub. No.: US 2017/0250810 A1
(43) Pub. Date: Aug. 31, 2017

(54) DYNAMIC MULTIPLE-APPLICATION SYSTEMATIC FRAMEWORK FOR INTEGRATED CIRCUIT CARD AND INFORMATION PROCESSING METHODS BASED ON THE FRAMEWORK

(71) Applicant: JING KING TECH HOLDINGS PTE. LTD., Singapore (SE)

(72) Inventor: Sun GUOHUA, SINGAPORE (SG)

(73) Assignee: JING KING TECH HOLDINGS PTE. LTD., Singapore (SG)

(21) Appl. No.: 15/519,544

(22) PCT Filed: Oct. 16, 2015
(86) PCT No.: PCT/SG2015/050393

§ 371 Date: Apr. 15, 2017

(30) Foreign Application Priority Data
Oct. 17, 2014 (CN) 201410550722.4

(51) Int. Cl. H04L 9/08; G06K 19/07; G06Q 20/36; G06Q 20/40; G06Q 20/34; H04L 9/32; G06Q 20/38

(52) U.S. Cl. CPC H04L 9/0894; H04L 9/0861; H04L 9/3242; H04L 9/3226; G06K 19/0723; G06Q 20/3829; G06Q 20/4014; G06Q 20/4012; G06Q 20/341; G06Q 20/36; G06Q 2220/00

(57) ABSTRACT

A multiple-application systematic framework for an IC card comprising a card issuer device 10, a service provider device 20 and a user terminal device 30, in which the three devices are interconnected by a first communications means. The card issuer device 10 comprises a card-issuing module 100 and a service provider management module 101. The service provider device 20 comprises a service module 200. The user terminal device 30 comprises an IC card 300 supplied by a card issuer and a communications device 301 comprising an application control module 3010, the IC card 300 comprises an authentication and security management module 3000 and a multi-application data storage area 3001. The communications device 301 and the IC card 300 communicate through a second communications means. The service provider management module 101 enables the service module 200 to use storage space in the multi-application data storage area 3001 for providing a service to a user via a service token, and the service module 200 communicates with the application control modulo 3010 enable a user and/or at least one service provider to manipulate one or more service tokens in the IC card 300.

### FIELD OF THE INVENTION

The present invention relates to a multi-application framework for integrated circuit (IC) cards and information processing methods based on the framework for management of various applications on IC cards. The IC card application industries include internet banking, mobile banking, third-party payment, online shopping, e-wallet, e-ticket, e-certification and tokenization.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

IC cards have been used and developed for decades and are capable of providing personal identification, authentication, data storage and application processing. Typically, an IC card is in a form of a contact card or is contact-based in which the IC card is required to be inserted into a card reader which must be connected to a drive device such as a computer for any data exchange to take place. This limits the applications for IC cards, in particular, mobile applications, which cannot be realised by contact-based IC cards as such cards are applied only to offline places without relying on the internet. An example would be metro cards, where they are purchased and recharged at operating companies or self-service machines and then used for public transport, all offline places.

However in the recent years, contactless IC cards and dual-interface IC cards (i.e. with contact and contactless functions) have emerged. In contrast to contact IC cards, contactless and dual-interface IC cards do not require a card reader for data exchange; these cards exchange data with read-write devices (card readers) through Near Field Communication (NFC). As a result more focus has been placed on the development of IC card applications than before. Pursuant to this, there exist an increasingly wide range of applications for contactless IC cards in the form of all-purpose metro cards, bank cards, social security cards, parking cards and gate cards, just to list some examples. New applications for such cards continue to emerge as people become more accustomed to using them.

As mobile phones with NFC functions are becoming more prevalent, such phones can substitute NFC read-write devices (card readers) in addition to having other communication functions and can be directly connected to the internet wirelessly. This opens up a new platform for contactless and dual-interface IC cards as mobile phones can provide the foundation for online applications of such IC cards and can meet the current Online to Offline (O2O) needs.

However, almost all existing IC card applications are supplied by the card issuers and are ‘unilateral’ in nature. A metro card which allows users to enjoy services provided by the card issuer only is an example to illustrate a ‘unilateral’ application. Another example of such an application pertains to bank cards, in which only the card-issuing bank can supply applications to the IC card issued. With such ‘unilateral’ applications, the end user of such IC cards will end up having to carry around multiple cards, as each card is for a different service provided by the corresponding card-issuing party.

In recent years, card issuers such as banks or rail operators have issued cards which possess a plurality of applications for functions or services ranging from traffic fines or road toll payment, social security and healthcare functions etc.. These functions are fixed at the time of issuance of the IC cards and a user cannot delete, add, substitute or alter the different functions. In the event that some or most of the functions on the IC card are of no interest to the user, the user only has the choice of ignoring such functions and is unable to delete or substitute them for other functions that are of interest to him/her.

Due to the fixed functions on such IC cards, the systematic framework for such fixed-functioned IC cards will involve only the management of two parties—the card issuers and service providers. To allow for a dynamic multiple-application IC card where a user is allowed to delete, add, substitute or alter the different functions on an IC card will involve a more complex management of all three parties.

The adoption of the Europay MasterCard Visa (EMV) standard has also been hampered by issues surrounding tokenization. The fixed functions of existing IC card applications are unable to meet the requirements of tokenization which is a pre-requisite for the EMV standard. In addition, although tokenization improves enterprise security, security issues have remained a barrier to greater electronic and mobile commerce adoption due to the lack of standards and coordination between card issuers, service providers and users which affects the widespread use of tokens.

The present invention attempts to overcome at least in part some of the aforementioned disadvantages.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention, there is provided a multiple-application systematic framework for an IC card comprising:

(a) a card issuer device 10, the card issuer device 10 comprises a card-issuing module 100 and a service provider management module 101;

(b) a service provider device 20, the service provider device 20 comprises a service module 200;

(c) a user terminal device 30, the user terminal device 30 comprises an IC card 300 supplied by a card issuer and a communications device 301 comprising an application control module 3010, the IC card 300 comprises an authentication and security management module 3000 and a multi-application data storage area 3001;

wherein the card issuer device 10, the service provider device 20 and the user terminal device 30 interconnect via a first communications means and the communications device 301 and the IC card 300 communicate through a second communications means,

the service provider management module 101 enables the service module 200 to use storage space in the multi-application data storage area 3001 for providing a service to a user via a service token, and the service module 200 communicates with the application control module 3010 to enable a user and/or at least one service provider to manipulate one or more service tokens in the IC card 300.

Preferably, manipulating one or more service tokens in the IC card 300 by the user and/or the service provider comprises generating, modifying, checking, inspecting or deleting one or more service tokens in the IC card 300.

Preferably, the card-issuing module 100 is operable to generate a unique identification (ID) for the IC card 300, store the unique ID in a database of the card issuer, generate encryption and decryption secret key (EKey) and verification secret key (MKey) for the IC card 300 and write into the IC card 300 the unique ID, EKey and MKey.

Preferably, the card-issuing module 100 is further operable to write the authentication and security management module 3000 and the multi-application data storage area 3001 into the IC card 300.

Preferably, the unique ID of the IC card 300 is expressed in ordinal numbers or as the original card number of the IC card 300 or the account number of the user.

Preferably, the EKey and the MKey are generated through Algorithm A using a Master Key of the card issuer and the unique ID of the IC card 300 as parameters.

Preferably, the Algorithm A is a general symmetric or asymmetric algorithm and the Master Key is defined by the card issuer or generated by a computer system of the card issuer device 10.

Preferably, the service provider management module 101 is operable to allocate a unique service provider ID (SID) to the service provider, encrypt an information management secret key (SKey) provided by the service provider to the user and generate a MAC check code for the SID, encrypted SKey and service token to be written into the IC card 300 by the service provider.

Preferably, the SID, encrypted SKey and service token is written onto the IC card 300 upon verification of the MAC code.

Preferably, the service module 200 is operable to retrieve a user ID and values of the counter in the IC card 300, retrieve the service token and the SKey generated for the user from the service provider device 20, and provide the card issuer with the user ID and values of the counter and SKey generated for the user, and is further operable to obtain from the card issuer the encrypted SKey, SID and MAC check code.

Preferably, the service module 200 is further operable to record the user ID and the SID into a database of the service provider and to submit the encrypted SKey, SID, service ID and MAC check code to the user via the first communications means in a prescribed format.

Preferably, wherein after the user has obtained the service token from the service provider, either party wishes to modify the service token, the service module 200 is operable to collect the user ID and values of the counter in the IC card 300 and the modified service token information from the service provider device 20.

Preferably, the service module 200 further operates to generate an SKey through Algorithm S using a Master Key of the service provider and the user ID as parameters, obtain from the database of the service provider the corresponding SID using the user ID and generate a SMAC check code through Algorithm A2 using the SKey, SID, values of the counter and modified service token information as parameters, and send the above to the user via the first communications means together with the SID and the modified service token.

Preferably, wherein after the user has obtained the service token from the service provider, and the service provider wishes to inspect the relevant service token, the service module 200 operates to acquire the user ID and values in the counter of the user's IC card 300; the service module 200 also operates to generate an SKey through Algorithm S using the service provider's Master Key and the user ID as parameters, obtain from the database of the service provider the corresponding SID using the user ID and generate a SMAC check code through Algorithm A2 using the SKey, SID, values of the counter as parameters; and send the Skey, SID and SMAC check code to the user via the first communications means; the service module 200 is further operable to send the generated information to the service provider device 20 for inspection after verification and return by the user.

Preferably, wherein after the user has obtained the service token from the service provider, the service provider wishes to delete the service token, the service module 200 operates to collect the user ID and values in the counter of the user's IC card 300 and retrieve from the service provider device 20 the flag bit that represents the information deletion; the module 200 also operates to generate an SKey through Algorithm S using the service provider's Master Key and the user ID as parameters, obtain from the database of the service provider the corresponding SID using the user ID and generate a SMAC check code through Algorithm A2 using the SKey, SID, values of the counter and the information set as deleted by the service provider flag bit in the formatting of the service token as parameters; and further operates to send the generated information to the user via the first communications means together with the SID and the information set as deleted by the service provider flag bit in the format of the service token.

Preferably, the authentication and security management module 3000 is a software program in the user's IC card 300 and operates to communicate with the application control module 3010 in the user's communications device 301 via the second communication means; conduct security authentication and encryption and decryption with the module 3010; receive control instructions of the card issuer, service provider or user transmitted by the module 3010 and read, write in, modify, check or delete data in the multi-application data storage area 3001; and to output data or calculation results to the module 3010.

Preferably, the security authentication and encryption and decryption operation are based on common symmetric or asymmetric algorithms.

Preferably, the authentication and operation processes involve ID, EKey, SID, MAC check code, SMAC check code, SKey and values in the counter.

Preferably, the values in the counter is a positive integer and increases by one after each participation in the authentication and encryption and decryption operation.

Preferably, wherein when the service provider or user modifies the service token in the user's IC card 300 and after the authentication and security management module 3000 sends the user ID and values of the counter to the service module 200, the module 3000 operates to obtain from the module 200 the SID, SMAC check code and service token modified by the service provider via the application control module 3010; the module 3000 further operates to generate a SMAC check code through Algorithm A2 using values in the counter, SID, corresponding SKey and modified service token as parameters; such SMAC check code is compared to the existing SMAC check code; and the modified service token is written into the corresponding data storage area if the SMAC check code is correct.

Preferably, wherein when the service provider checks the service token in the user's IC card 300, the authentication and security management module 3000 operates to send the user ID and values of the counter to the service module 200 and obtains in return the SID and SMAC check code from the module 200 via the application control module 3010; the module 3000 further operates to work out a SMAC check code through Algorithm A2 using values in the counter, SID and corresponding SKey as parameters and compare such SMAC check code with the existing SMAC check code; and proceeds to send the service token to the module 200 if the SMAC code is correct.

Preferably, wherein when the service provider deletes the service token in the user's IC card 300 and after sending the user ID and values in the counter to the service module 200, the authentication and security management module 3000 operates to obtain the SID, SMAC check code and the information set as deleted by the service provider flag bit in the format of the service token from the module 200 via the application control module 3010; the module 3000 further operates to generate a SMAC check code through Algorithm A2 using values in the counter, SID, SKey corresponding to the SID and the information set as deleted by the service provider flag bit in the format of service token and compare such SMAC check code with the existing SMAC check code; and proceeds to write the corresponding flag bit in the format of the service token into the corresponding service provider flag bit in the format of the service token if the result is correct.

Preferably, wherein when the user checks the service token in the IC card 300 via the communications device 301, the authentication and security management module 3000 operates to verify the user's PIN; and upon successful authentication, proceeds to send all service token(s) in the multi-application data storage area 3001 to the application control module 3010.

Preferably, wherein when the user deletes the service token in the IC card 300 via the communications device 301, the authentication and security management module 3000 operates to verify the user's PIN; and upon successful authentication, proceeds to receive from the application control module 3010 the user flag bit that represents the information deletion selected by the user and write into the specified user flag bit in the format of the service token such deleted information.

Preferably, the multi-application data storage area 3001 is a unique storage space in the user's IC card 300 for storing one or more service tokens provided by at least one service provider, SID and SKey.

Preferably, the storage size of the multi-application storage area 3001 is set by the card issuer at the time of issuance of the IC card 300.

Preferably, the user terminal device 30 further comprises a communications device 302 comprising an application module 3020.

Preferably, the application control module 3010 is a software that operates in the communications device 301; and operates to communicate and exchange data with the service module 200 through the first communications means; exchanging data with the IC card 300 through the second communications means; exchanging data with the application module 3020 in the communications device 302 via a third communications means; and further operates to facilitate data exchange between the user and the service provider, the IC card 300 or the communications device 302 via mobile keyboard and display screen.

Preferably, the application module 3020 operates to communicate and exchange data with the service module 200 in the communications device 302 via the first communications means and further operates to exchange data with the application control module 3010 via the third communication means.

Preferably, the third communications means is one of wireless communication means and code scanning and keyboard input means.

Preferably, the wireless communication means is one of Wi-Fi, Bluetooth and infra-red.

Preferably, the first communications means is one of the Internet, intranet and any network suitable for interconnecting the card issuer device 10, the service provider device 20 and the user terminal device 30.

Preferably, the second communications means is a wireless communication means comprising Wi-Fi, Bluetooth, infra-red and near field communication (NFC).

In accordance with a second aspect of the present invention, there is provided a method for issuing a multiple-application IC card by a card issuer to a user according to the first aspect of the invention comprising:

(a) generating the user ID according to the user's ID features, the generation method defined by the card issuer, and recording the user ID in the database of the card issuer by the card-issuing module 100;

(b) obtaining the Master Key from the card issuer by the module 100, where the Master Key is inputted manually by the card issuer or generated by the computer system;

(c) generating the user EKey and MKey through symmetric or asymmetric algorithm (Algorithm A) using the user ID in Step (a) and the Master Key in Step (b) as parameters by the module 100; and

(d) writing the user ID, EKey, MKey, the authentication and security management module 3000 and the multi-application data storage area 3001 into the IC card 300 by the module 100 through an IC card read-write device; where the writing process includes the initialization of counters in the module 3000.

In accordance with a third aspect of the present invention, there is provided a method for writing the service token into the user's IC card according to the second aspect of the present invention comprising:

(a) acquiring the user ID and values in the counter from the authentication and security management module 3000 in the user's IC card 300 by the service module 200 via the application control module 3010 in the user's communications device 301; and upon successful authentication, sending the user ID and values in the counter to the module 200 by the module 3000 via the module 3010;

(b) acquiring the service token information and the SKey generated for the specific user by the service provider from the service provider device 20 by the module 200;

(c) submitting the user ID, values in the counter and the service token information and SKey in Step (b) to the service provider management module 101 of the card issuer by the module 200;

(d) generating, upon successful authentication, the user's EKey and MKey using the obtained user ID, encrypting the SKey with Algorithm A1 using EKey and the values in the counter and generating the SID and a MAC check code to be sent to the module 200 by the module 101; the SID is generated according to SID features and the generation methods are defined by the card issuer; where the MAC check code is generated with Algorithm A2 using values in the counter, MKey, SID, encrypted SKey and service token information;

(e) sending the service token information and encrypted SKey, SID and MAC check code to the module 3000 by the module 200 through the module 3010 in the communications device 301; and

(f) verifying information provided by the service provider by the module 3000.

Preferably, wherein the module 3000 verifies the information provided by service provider as follows:

processing the acquired service provider SID, service token, encrypted S Key, MKey and values in the counter with Algorithm A2 and comparing the result with the MAC check code sent from the module 200;

upon successful verification, decrypting the encrypted SKey via Algorithm A1 using the user's Ekey and values in the counter and inputting into the multi-application storage area 3001 together with the SID and the service token information in the prescribed format of the authentication and security management module 3000; transmitting the encrypted data between the module 101 and the module 200, between the module 200 and the module 3010, between the module 200 and the module 3020 and between the module 3020 and the module 3010.

In accordance with a fourth aspect of the present invention, there is provided a method for modifying the service token in the user's IC card according to the second aspect of the present invention comprising:

(a) submitting the user ID and values in the counter to the service module 200 by the authentication and security management module 3000 of the user's IC card 300 via the application control module 3010 in the communications device 301;

(b) generating the SKey with Algorithm S using the user ID and the service provider's Master Key as parameters by the module 200, and further obtaining SID corresponding to the user ID from the database of the service provider by the module 200;

(c) after acquiring the modified service token information from service provider device 20, further generating a SMAC check code via Algorithm A2 using the SKey, SID, values in the counter and the modified service token information as parameters, and sending the SMAC check code to the module 3000 through the module 3010 along with the SID and the modified service token information by the module 200;

(d) after receiving the SID, SMAC check code and the modified service token information, further generating a SMAC check code via Algorithm A2 using the SKey, SID, values in the counter and the modified service token information as parameters by the module 3000; and

(e) comparing the generated SMAC check code with the one received from the module 200 by the module 3000; if the two are identical, the service token information modified by the service provider will be written into the corresponding data storage area in the multi-application data storage area 3001.

In accordance with a fifth aspect of the present invention, there is provided a method for inspecting the service token in the user's IC card according to the second aspect of the present invention comprising:

(a) submitting the user ID and values in the counter to the service module 200 by the authentication and security management module 3000 of user's IC card 300 via the application control module 3010 in the user's communications device 301;

(b) generating a SKey via Algorithm S using the user ID and the service provider's Master Key as parameters and obtaining the SID corresponding to the user ID from the database of the service provider by the module 200;

(c) generating a SMAC check code via Algorithm A2 using the SKey, SID and values in the counter as parameters by the module 200;

(d) sending the SID and SMAC check code to the module 3000 by the module 200 through the module 3010;

(e) after receiving the SID and SMAC check code, generating a SMAC check code via Algorithm A2 using the SKey, SID and values in the counter as parameters by the module 3000; and

(f) comparing the generated SMAC check code with the one received from the module 200 by the module 3000; if they are identical, the service token corresponding to the SID will be sent to the module 200 via the module 3010 in the communications device 301.

In accordance with a sixth aspect of the present invention, there is provided a method for deleting the service token in the user's IC card according to the second aspect of the present invention comprising:

(a) submitting the user ID and values in the counter to the service module 200 by the authentication and security management module 3000 of the user's IC card 300 via the application control module 3010 in the user's communication device 301;

(b) generating a SKey via Algorithm S using the user ID and service provider's Master Key as parameters and obtaining the SID corresponding to the user ID from the database of the service provider by the module 200;

(c) obtaining the service provider flag bit representing the information deletion from the service provider device 20, generating a SMAC check code via Algorithm A2 using the SKey, SID, values in the counter and the said service provider flag bit as parameters by the module 200; sending the SMAC check code to the module 3000 via the module 3010 along with SID and the said service provider flag bit;

(d) after receiving the SID, SMAC check code and the information set as deleted by the service provider flag bit in the formatting of the service format, generating a SMAC check code via Algorithm A2 using the SKey, SID, values in counter and such information as parameters by the module 3000; and

(e) comparing the generated SMAC check code with the check code received from the module 200; deleting the information set as deleted by the flag bits of the service provider if they are identical; and inputting the information into the corresponding service provider flag bit in the format of the service token by the module 3000.

In accordance with a seventh aspect of the present invention, there is provided a method for inspecting the service token in the user's IC card according to the second aspect of the present invention comprising:

(a) user inputting PIN code into the communications device 301, and the application control management module 3010 in the communications device 301 sending the PIN code to the authentication and security management module 3000 via the second communications means;

(b) verifying the PIN code inputted by the user by the module 3000; and

(c) if the PIN code is correct, submitting all service token information stored in the multi-application storage area 3001 to the module 3010 by the module 3000.

In accordance with an eighth aspect of the present invention, there is provided a method for deleting the service token in the user's IC card according to the second aspect of the present invention comprising:

(a) user inputting PIN code into the communications device 301, and the application control management module 3010 in the communications device 301 sending the PIN code to the authentication and security management Module 3000 via the second communications means;

(b) verifying the PIN code inputted by the user by the module 3000; and

(c) if the PIN code is correct, obtaining the deletion information in the user flag bit selected by the user from the module 3010 and writing the deletion information into the user flag bit in the format of the specified service token by the module 3000.

Other aspects and advantages of the invention will become apparent to those skilled in the art from a review of the ensuing description, which proceeds with reference to the following illustrative drawings of various embodiments of the invention.

### BRIEF DESCRIPTION OF THE DRAWINGS

The present invention will now be described, by way of illustrative example only, with reference to the accompanying drawings, of which:

FIG. 1 is a basic structure diagram of the multi-application systematic framework for an IC card in accordance with an embodiment of the present invention;

FIG. 2 is a structure diagram of the card-issuing module of the framework of FIG. 1;

FIG. 3 is a structure diagram of the service provider management module of the framework of FIG. 1;

FIG. 4 shows the procedures or steps through which the service module of the framework of FIG. 1 submits a service token to a user;

FIG. 5 is a format chart of the framework's service token of the framework of FIG. 1;

FIG. 6 shows the procedures or steps through which the service provider (or user) of the framework of FIG. 1 gives the instruction to modify the service token in the IC card;

FIG. 7 shows the procedures or steps through which the service provider of the framework of FIG. 1 gives the instruction to check the service token in user's IC card;

FIG. 8 shows the procedures or steps through which the service provider of the framework of FIG. 1 gives the instruction to delete service token in the user's IC card;

FIG. 9 shows the procedures or steps of security authentication, encryption and decryption between the communications device and the user's IC card of the framework of FIG. 1;

FIG. 10 shows the procedures or steps through which the service token in the user's IC card is modified as instructed by the service provider (or user) of the framework of FIG. 1;

FIG. 11 shows the procedures or steps through which the service token in the user's IC card is checked as instructed by the service provider of the framework of FIG. 1;

FIG. 12 shows the procedures or steps through which the service token in the user's IC card is deleted as instructed by the service provider of the framework of FIG. 1;

FIG. 13 shows the procedures or steps through which the user of the framework of FIG. 1 checks the service token in the IC card via the communications device;

FIG. 14 shows the procedures or steps through which the user of the framework of FIG. 1 deletes the service token in the IC card via the communications device;

FIG. 15 is the structure diagram of the multi-application data storage area of the framework of FIG. 1;

FIG. 16 shows the information processing methods of the framework of FIG. 1 for the communication and data exchange between the application control module in the (first) communications device and the service provider's service module, the user's IC card and the application control module in the other (second) communications device; and

FIG. 17 shows the information processing methods of the framework of FIG. 1 for the communication and data exchange between the application control module in the (second) communications device and the application control module in the (first) communications device, the service provider's service module and the user's IC card.

### DETAILED DESCRIPTION OF THE INVENTION

Particular embodiments of the present invention will now be described with reference to the accompanying drawings. The terminology used herein is for the purpose of describing particular embodiments only and is not intended to limit the scope of the present invention. Additionally, unless defined otherwise, all technical and scientific terms used herein have the same meanings as commonly understood by one of ordinary skill in the art to which this invention belongs.

The present invention discloses a multi-application framework for IC cards and information processing methods based on the framework for management of various applications on IC cards.

An IC card is like a computer; in theory, anyone who uses a computer can install, utilize, or delete one or several applications or software according to their own preferences. When a user manages one or several free, undefined or unregulated IC cards at will, they are managing “multiple applications”, but this is not within the scope of this invention. Instead, the present invention aims to allow a user or a service provider to freely delete, add, substitute or alter one or several different functions on an IC card in a secure manner. An example of “multiple applications of IC card” relating to the present invention is described as follows.

The characteristics of IC cards make them suitable for serving mass consumers, for example, as bank cards and metro cards. Serving mass consumers or customers through IC cards requires one IC card provider or card issuer and more than one application service providers, which forms the trilateral interactive relationship between the user, the card issuer and the service provider. The card issuer supplies the card, the user holds the card and the service providers each occupies independent storage space in the IC card for storing and marking information of the services they provide, to serve the users (the card issuer can also serve as a service provider). This is the definition of “multiple applications of IC card” referred to in the present invention.

To better understand the significance of the present invention's practical applications, there is provided the following illustration: when a bank issues bank cards with “multiple applications” as a card issuer, it can provide some storage space in the card for third-party service providers to offer services to the users; for example, when a user purchases movie tickets from a cinema online and pays for the tickets with a bank card, the cinema can input the ticket information into the storage space for the cinema on the bank card via the Internet; this enables the user to use the bank card as the movie ticket at the cinema. In the same way, users can use their bank cards as train tickets after they have paid online; here, the online ticket office is another third-party service provider.

While the storage space of a bank card is limited, third-party service providers are numerous; therefore, a set of scientific management methods is necessary for determining the priority between the service providers and other such issues; this is a core aspect of the present invention.

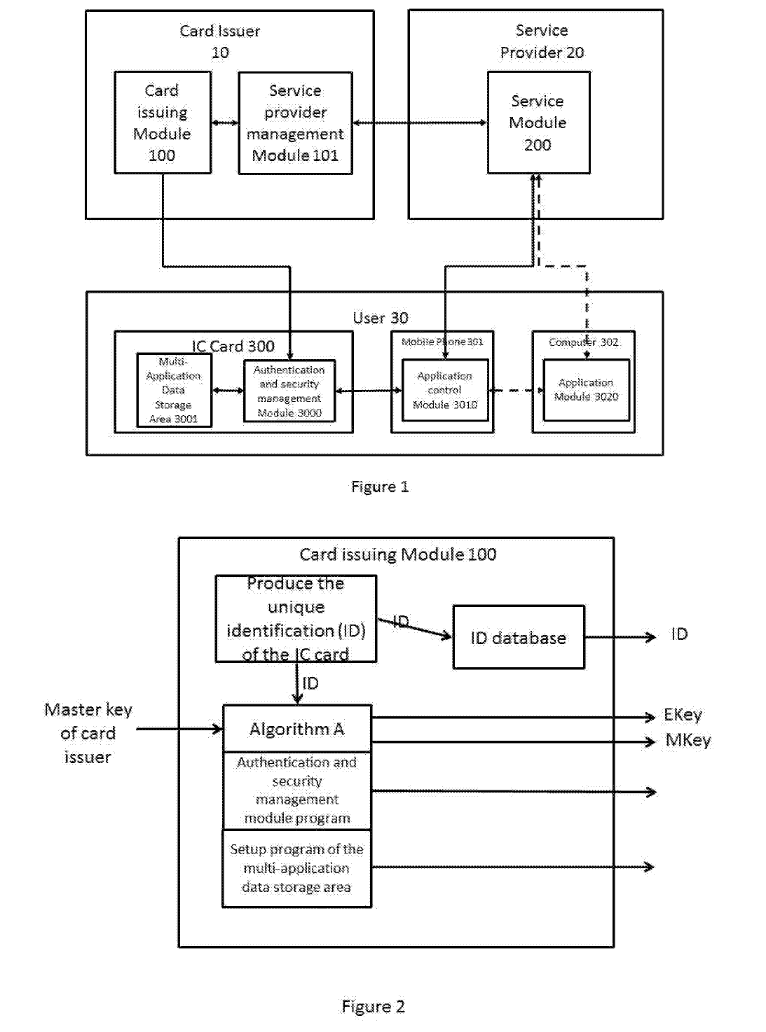

In accordance with a first embodiment of the invention, there is provided a multiple-application systematic framework for IC card relating to three parties, namely, a card issuer, a service provider and a user. The multi-application systematic framework comprises a card issuer device 10, a service provider device 20 and a user terminal device 30, as shown in FIG. 1.

The card issuer device 10, typically in the form of a computer system that is equipped with an IC card read-write device, comprises a card-issuing module 100 and a service provider management module 101. The service provider device 20, typically in the form of a computer system, comprises a service module 200. The user terminal device 30 comprises an IC card 300, which is supplied by a card issuer, and the IC card 300 comprises an authentication and security management module 3000 and a multi-application data storage area 3001. The user terminal device 30 further comprises a communications device 301 and the communications device 301 comprises an application control module 3010.

The card issuer device 10, the service provider device 20 and the user terminal device 30 are interconnected via a first communication means, in which the first communication means is typically in the form of the Internet, an intranet or any other network suitable for interconnecting the card issuer device 10, the service provider device 20 and the user terminal device 30. The communications device 301 and the IC card 300 communicate through a second communication means, in which the second communication means is typically in the form of a wireless communication means such as Wi-Fi, Bluetooth, infra-red and Near Field Communication (NFC). The communications device 301 is typically in the form of a mobile phone. In the present embodiment, the communications device 301 is a mobile phone.

The service provider management module 101 enables the service module 200 to use storage space in the multi-application data storage area 3001 for providing a service to a user via a service token, and the service module 200 communicates with the application control module 3010 to enable a user and/or at least one service provider to manipulate one or more service tokens in the IC card 300. A user and/or a service provider is able manipulate one or more service tokens in the IC card 300 by generating, modifying, checking, inspecting or deleting one or more service tokens in the IC card 300. Hence, the multi-application systematic framework advantageously provides for a dynamic multi-application IC card and management system where a user and/or one or more service providers can freely manipulate one or several different functions applications or software on an IC card and in a secure manner.

In another embodiment, the user terminal device 30 further comprises a communications device 302 and the communications device 302 comprises an application module 3020. The communications device is typically in the form of a computer. The application module 3020 of the communications device 302 communicates with the application control module 3010 of the communications device 301 via a third communications means. The application module 3020 operates to communicate and exchange data with the service module 200 in the communications device 302 via the first communications means and further operates to exchange data with the application control module 3010 via the third communication means. The third communications means is one of wireless communication means, such as Wi-Fi, Bluetooth and infra-red, and code scanning and keyboard input means.

In another embodiment, the communications device 301 is in the form of a computer having an IC card reader. The IC card reader may be an external device connectable to the computer or the IC card reader may be integrated into the computer. In such an embodiment, the computer with the IC card reader works in place of the mobile phone as described in the embodiment above.

A set of information processing methods based on the aforementioned multiple-application systematic framework for an IC card is described hereinafter in accordance with an embodiment of the invention. In particular, a method for issuing a multi-application IC card by a card issuer to a user comprises:

Step (a): generating the user ID according to the user's ID features, the generation method defined by the card issuer, and recording the user ID in a database of the card issuer by the card-issuing module 100;

Step (b): obtaining the Master Key from the card issuer by the module 100, where the Master Key is inputted manually by the card issuer or generated by the computer system;

Step (c): generating the user EKey and MKey through symmetric or asymmetric algorithm (Algorithm A) using the user ID in Step (a) and the Master Key in Step (b) as parameters by the module 100; and

Step (d): writing the user ID, EKey, MKey, the authentication and security management module 3000 and the multi-application data storage area 3001 into the IC card 300 by the module 100 through an IC card read-write device; where the writing process includes the initialization of counters in the module 3000.

The merits and advantages of the present invention are that it facilitates services provision to the mass customers through a single IC card, which is possessed by a user, in a way that involves one IC card provider or card issuer and more than one application service provider; a trilateral interactive relationship between the user, the card issuer and the service provider is formed wherein the card issuer issues an IC card, the user holds a single IC card and the service providers possess independent storage space in the IC card for storing and marking service information (the card issuer can also serve as a service provider), thereby realizing the “multiple applications of IC card” of the present invention.

The functions and working mechanisms of the above-mentioned functional modules are further described in detail as follows.

The card-issuing module 100 is operable to perform several functions. In an embodiment of the present invention and with reference to FIG. 2, the card-issuing module 100 is a software supplied by the card issuer for multi-application IC cards which functions to generate a unique ID for the IC card 300, store this unique ID in a database of the card issuer, generate encryption and decryption secret key (EKey) and verification secret key (MKey) for the IC card 300 and write into the IC card 300 the unique ID of the IC card 300, EKey and MKey. The card-issuing module 100 also writes the authentication and security management module 3000 and the multi-application data storage area 3001 into the IC card 300. The unique ID of the IC card 300 is expressed in ordinal numbers or as the original card number of the IC card 300 or the account number of the user. The EKey and the MKey are generated through Algorithm A using a Master Key of the card issuer and the unique card ID as parameters. Algorithm A is a general symmetric or asymmetric algorithm and the Master Key is defined by the card issuer or generated by a computer system of the card issuer device 10. The EKey and the MKey are also called ‘user keys’ and are crucial factors for mutual authentication, encryption and decryption communications between the card issuer device 10 and the user's IC card 300. The database of the card issuer can be contained in the card issuer device 10 or in the card-issuing module 100.

The service provider management module 101 is a software supplied by the card issuer to the service provider for the multi-application IC card 300. The module 101 functions or operates to allocate a unique service provider ID (SID) to the service provider, encrypt the information management secret key (SKey) provided by the service provider to the user and generate a MAC check code for the SID, encrypted SKey and service token to be written into the IC card 300 by the service provider. If the MAC code is correct upon verification, the mentioned information can be written into the user's IC card 300. Otherwise such information cannot be written into the IC card 300.

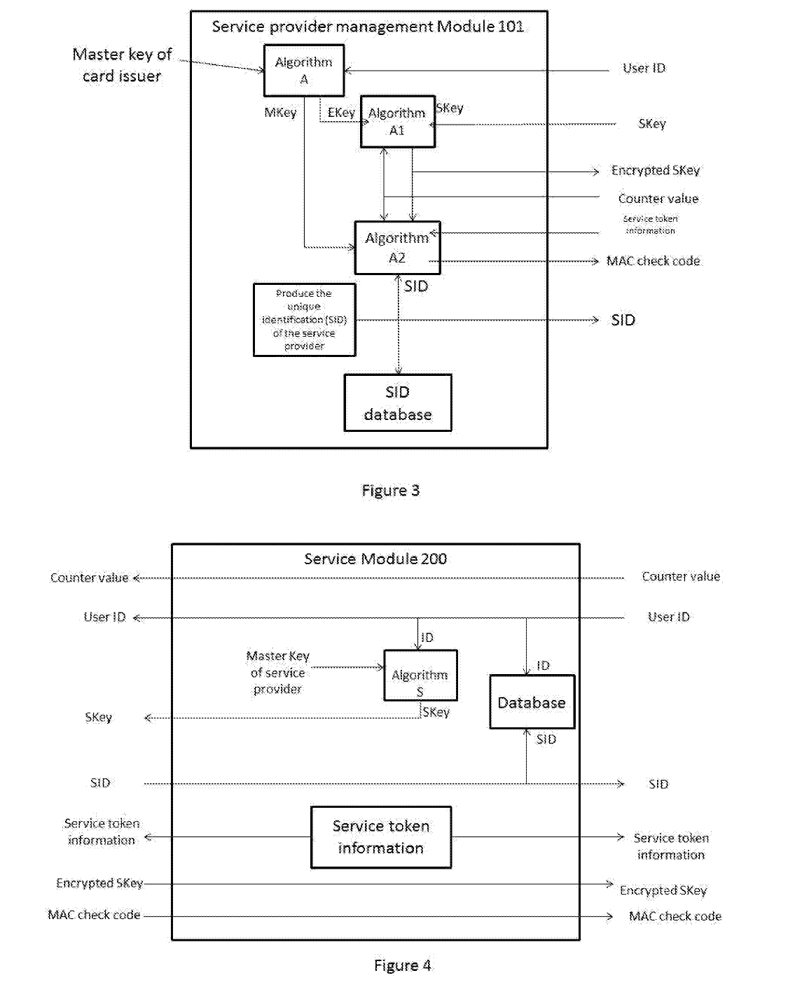

In the described embodiment, the card issuer is a bank which issues an IC card to a user and a service provider uses a specific storage space in the IC card to provide services to the user. The service provider would have received service fees paid by the user via the bank IC card. Therefore, the service provider can obtain the unique ID of the IC card and the values in the counter in the bank IC card. The service provider can then submit the unique ID and values in the counter to the bank (card issuer), while supplying a service token and SKey to be written into the user's IC card in order to apply for a storage space in the card. After receiving the application from the service provider, the bank (card issuer), through the module 101, allocates a unique SID for the service provider, records the SID into a database of the service provider and then generate a EKey and a MKey for the user through Algorithm A using the card issuer's Master Key and the user ID as parameters. The module 101 at the same time encrypts the SKey through Algorithm Al using the EKey and values in the counter as parameters. Thereafter, the module 101 generates a MAC check code through Algorithm A2 using the MKey, values in the counter, SID, encrypted SKey and the service token information as parameters. The MAC code, together with the SID and the encrypted SKey, is then submitted to the service provider's service module 200 (see FIG. 3). The SID can be expressed in ordinal numbers or as the service provider's bank account number or card number. Algorithms A1 and A2 can either be the same or common symmetric or asymmetric algorithms. The database of the service provider can be contained in the service provider device 20 or in the service module 200.

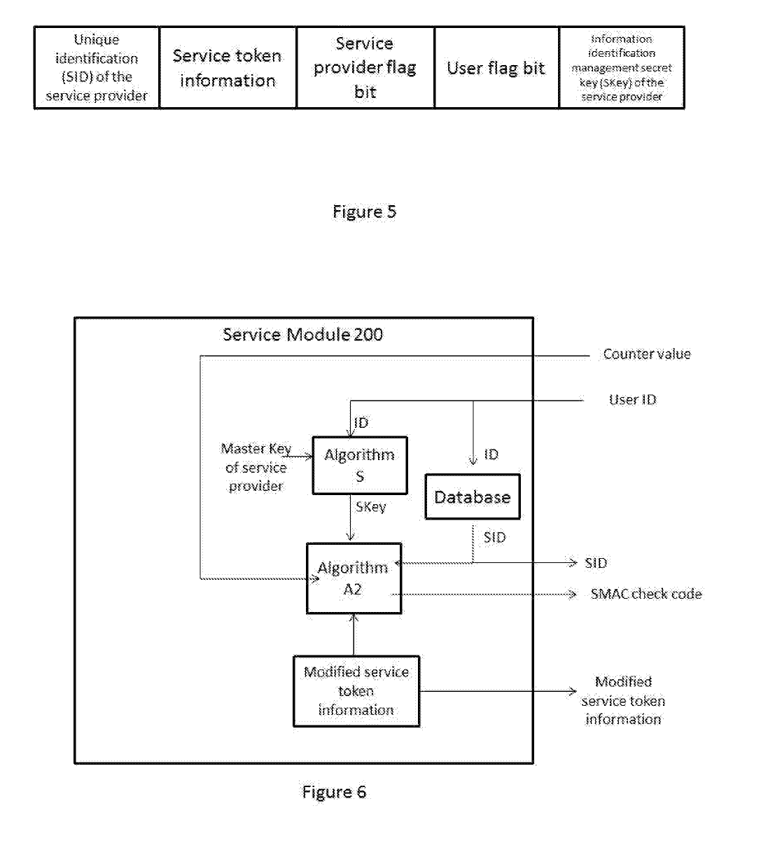

The service module 200 is a software provided by the service provider to the user to supply application services. The function of this module is that, when the user buys one or more service products or services from the service provider and wishes to use the bank IC card to carry the service token and to later manipulate the service token, such as to modify, check, inspect or delete the service token, this module 200 collects the user's ID and values of the counter in the IC card, collects from the service provider device 20 the service token and the SKey generated for the user, provides the card issuer (bank) with the above information, the user ID and the values in the user's IC card counter and then obtains from the card issuer (bank) the encrypted SKey, SID and MAC check code. The SKey is generated by the module 200 through Algorithm S using the service provider's Master Key, the SID and the MAC check code as parameters. The module 200 at the same time records the user ID and the SID into the database of the service provider. On this basis, the module 200 submits the encrypted SKey, SID, service ID and MAC check code to the user via the first communications means, which in this case the Internet, in the canonical format required by the IC card storage space (see FIG. 4). The service provider ID management SKey is a key factor for the service provider to manipulate service token information in the IC card, which comprises modifying, checking, inspecting or delete service token information in the IC card after setting up its independent storage area in the card. FIG. 5 shows the format of service token information.

In an event where after the user has bought or obtained the service token from the service provider, and either party wishes to modify the service token, the module 200 collects the user's ID and the values in the IC card counter as well as the modified service token information from the service provider device 10. The module 200 also generates an SKey through Algorithm S using the service provider's Master Key and user's ID as parameters, obtains from the database of the service provider the corresponding SID using the user ID and generate a SMAC check code through Algorithm A2 using the SKey, SID, values of the counter and modified service token information as parameters, and sends the above to the user via a wireless communication means together with the SID and the modified service token (see FIG. 6).

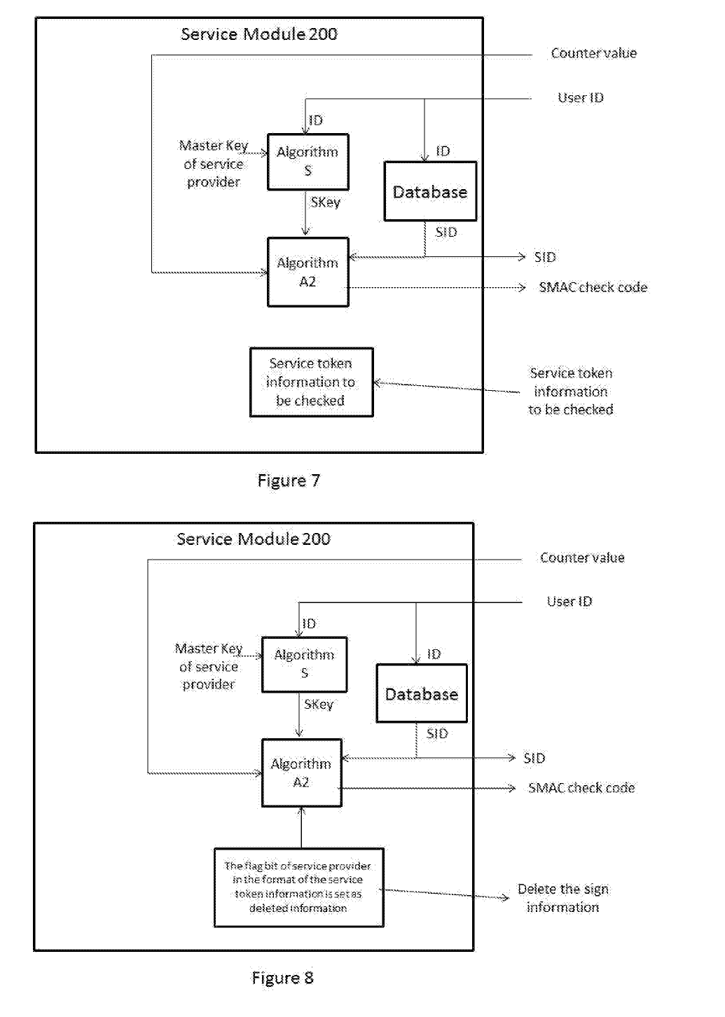

In an event where after the user has bought or obtained the service token from the service provider, and the service provider wishes to inspect the relevant service token, the module 200 acquires the user's ID and values in the user's IC card counter. The module 200 also generates a SKey through Algorithm S using the service provider's Master Key and user's ID as parameters, obtains from the database of the service provider the corresponding SID using the user ID and generate a SMAC check code through Algorithm A2 using the SKey, SID and values of the counter as parameters. The above generated information is then sent to the user via a wireless communication together with the SID. After the user has verified and returned the information, the module 200 will then send the information to the service provider device 20 for inspection (see FIG. 7).

In an event where after the user has bought or obtained the service token from the service provider, the service provider wishes to delete the service token, the module 200 collects the user's ID and values in user's IC card counter and retrieve in the service provider device 20 the flag bit that represents the information deletion. The module 200 generates a SKey through Algorithm S using the service provider's Master Key and the user's ID as parameters, retrieves from the database of the service provider the corresponding SID using the user ID and generate a SMAC check code through Algorithm A2 using the SKey, SID, values of the counter and the information set as deleted by the service provider flag bit in the formatting of the service token as parameters. Such generated information will be sent to the user via a wireless communication together with the SID and the information set as deleted by the service provider flag bit in the format of the service token. If the service provider flag bit in the format of the service token indicates ‘deleted’, it means that the service token information has been deleted by the service provider (see FIG. 8).

The authentication and security management module 3000 is a software or software program in the user's IC card. The module 3000 functions to communicate with the application control module 3010 in the user's mobile phone via NFC in this described embodiment. The module 3000 also conducts security authentication and encryption and decryption with the module 3010, receives control instructions of the card issuer, service provider or user transmitted by the module 3010 and read, write in, modify, check or delete data in the multi-application data storage area 3001 in accordance with the control instructions, and outputs data or calculation results to the module 3010 following its control instructions. The aforementioned security authentication and encryption and decryption operation are based on common symmetric or asymmetric algorithms and, depending on application requirements, are authentication and operation processes involving ID, EKey, SID, MAC check code, SMAC check code, SKey and values in the counter. Amongst these, the counter's value is a positive integer and increases by one after each participation in the authentication, mencryption and decryption operation (see FIG. 9).

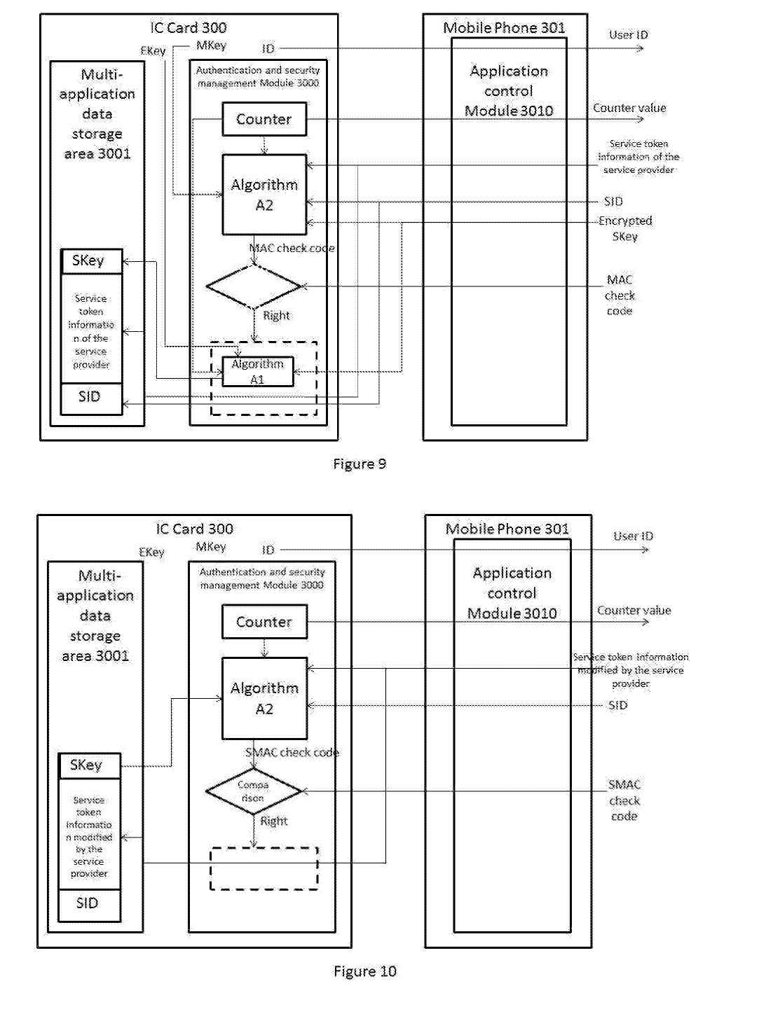

When the service provider or user modifies the service token in the user's IC card and after the authentication and security management module 3000 sends the user's ID and values of the counter to the service provider's service module 200, the module 3000 obtains from the module 200 the SID, SMAC check code and service token modified by the service provider via the mobile phone application control module 3010. The module 3000 then generates a SMAC check code through Algorithm A2 using values in the counter, SID, corresponding SKey and modified service token as parameters. Such SMAC check code is further compared to the existing SMAC check code; if the code is correct, the modified service token will be written into the corresponding data storage area. Otherwise the information cannot be written into the user's IC card (see FIG. 10).

When the service provider checks the service token in the user's IC card, the authentication and security management module 3000 sends the user ID and values of the counter to the service module 200 and obtains in return the SID and SMAC check code from the module 200 via the application control module 3010. The module 3000 will work out a SMAC check code through Algorithm A2 using values in the counter, SID and corresponding SKey as parameters and compare such SMAC check code with the existing SMAC check code. If the code is correct, the service token corresponding to the SID will be sent to the module 200 through the module 3010. Otherwise the module 3000 will not send the service token (see FIG. 11).

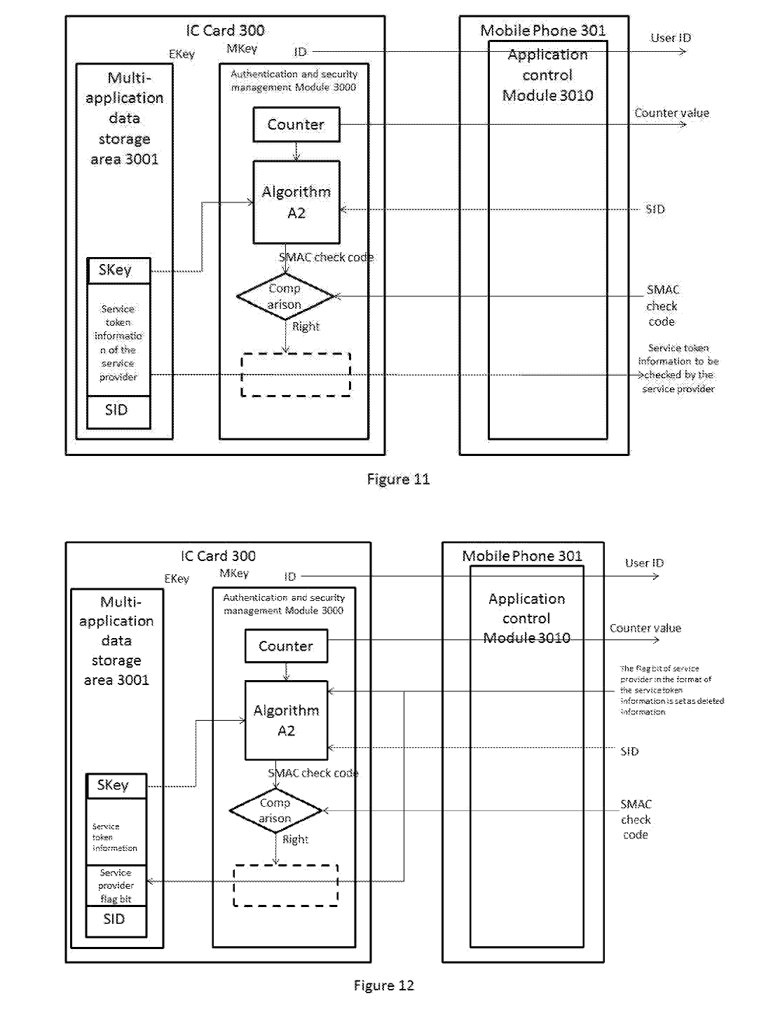

When the service provider deletes the service token in the user's IC card and after sending the user's ID and values in the counter to the service module 200 of the service provider, the authentication and security management module 3000 obtains the SID, SMAC check code and the information set as deleted by the service provider flag bit in the format of the service token from the module 200 via the mobile phone application control module 3010. The module 3000 thereafter generates a SMAC check code through Algorithm A2 using values in the counter, SID, SKey corresponding to the SID and the information set as deleted by the service provider flag bit in the format of service token and compare such SMAC check code with the existing SMAC check code. If the result is correct, the information set as deleted by the service provider flag bit in the format of the service token will be written into the corresponding service provider flag bit in the format of service token. Otherwise, such information cannot be written into the user's IC card (see FIG. 12).

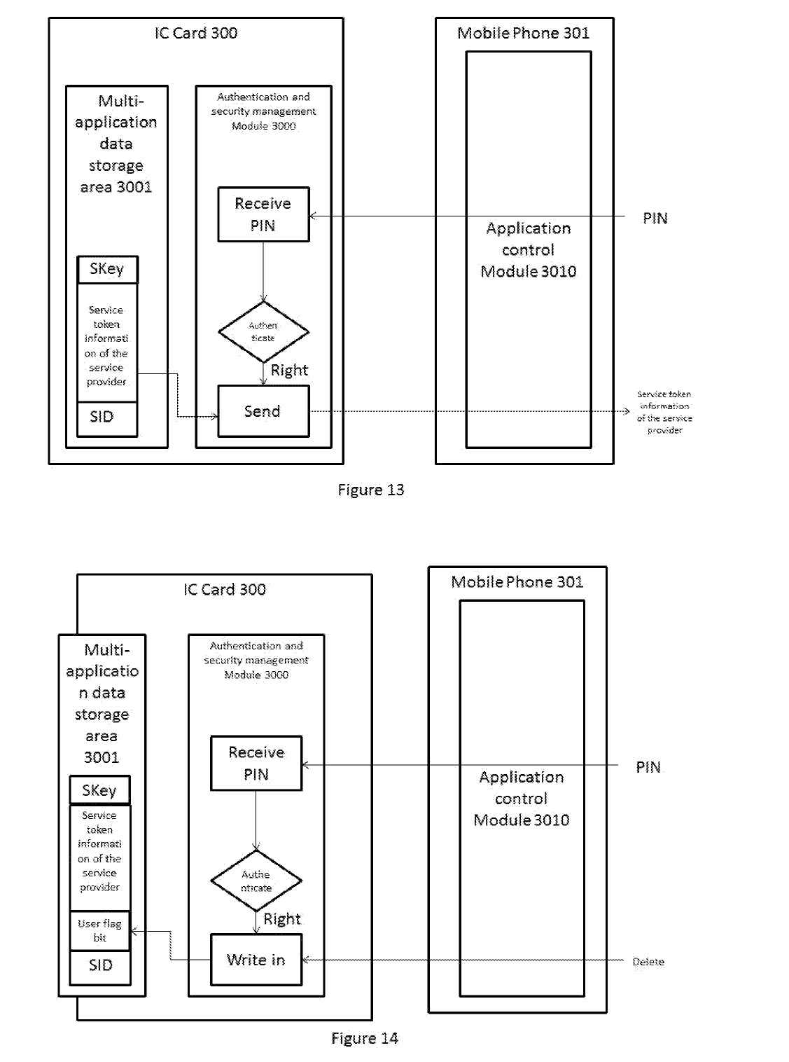

When the user checks the service token in the IC card via mobile phone, the authentication and security management module 3000 will verify the user's PIN; if the PIN passes the authentication, the module 3000 will send all service tokens in the multi-application data storage area 3001 to the application control module 3010. If the PIN is incorrect, the module 3000 will not send all the service token in the multi-application data storage area 3001 to the module 3010 (see FIG. 13).

When the user deletes the service token in the IC card via the mobile phone, the authentication and security management module 3000 will verify the user's PIN; if the PIN passes authentication, the module 3000 will receive from the application control module 3010 the user flag bit that represents the information deletion selected by the user and write into the specified user flag bit in the format of the service token such deletion information. If the PIN is incorrect, the above information cannot be written into the user's IC card. If the user flag bit in the format of the service token indicates ‘deleted’, it means that the service token has been deleted by the user (see FIG. 14).

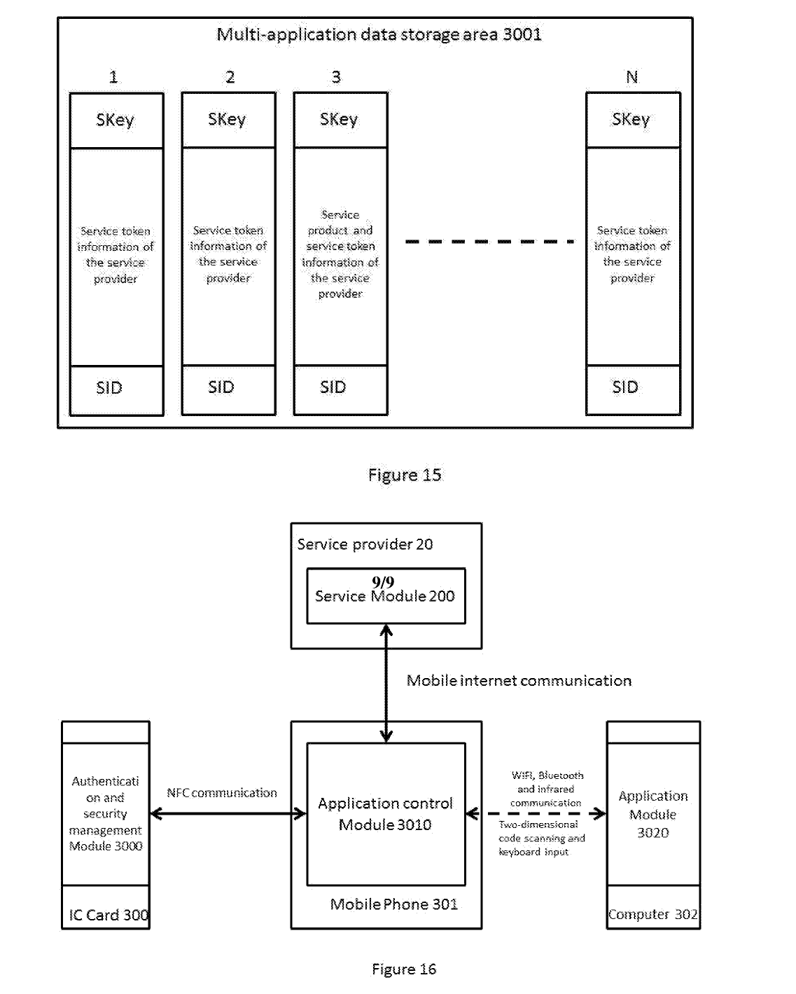

The multi-application data storage area 3001 is a unique storage space in the user's IC card for storing one or more service tokens provided by the service provider, SID and SKey. The storage area 3001 can store information of multiple service providers; its storage size is set by the card issuer upon issuance (see FIG. 15).

The application control module 3010 is a software program that operates in the user's mobile phone. Its functions include communicating and exchanging data with the service provider's service module 200 through a wireless communication, exchanging data with the user's IC card through NFC, exchanging data with the application module 3020 in the user's computer via wireless communication, such as Wi-Fi, Bluetooth and infrared devices, or code scanning and keyboard input as well as facilitating data exchange between the user and the service provider, the IC card or the user's computer via mobile keyboard and display screen. The module 3010 is able to achieve data conversion in various different communication modes (see FIG. 16).

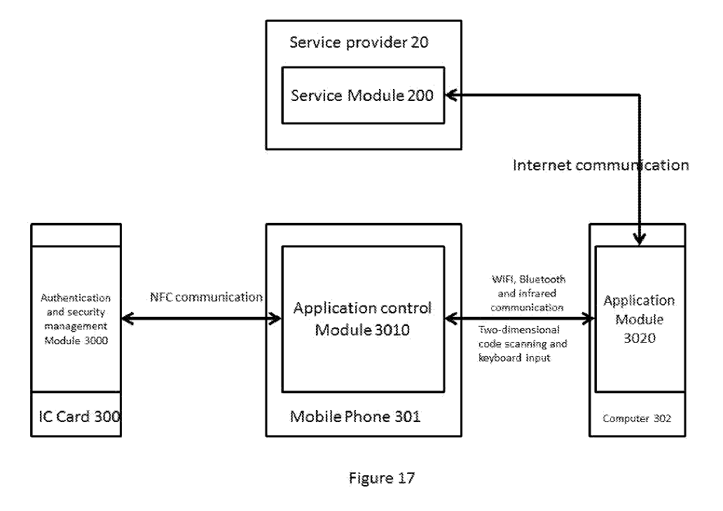

The application module 3020 is a software program that operates in the user's communication device, which in this case is a computer. The module 3020 has a special role in the present invention. With advancements in technology relating to the Internet and wireless communication, applications are no longer limited to fixed networks; the rapidly developing mobile internet (accessing the Internet via a mobile device) is likely to overtake traditional internet. When dealing or communicating with service providers, the user may choose to use either a mobile phone (mobile internet) or a computer (fixed internet). When mobile phones are used, the above systematic framework as referenced in FIG. 1 can operate without the module 3020 (as referenced by the dotted portion in FIG. 1). As such, the module 3020 becomes part of the systematic framework only when the user chooses to use a computer to deal or communicate with the service providers. The functions of the module 3020 include communicating and exchanging data with the service provider's service module 200 in the user's computer via a wireless communication means and exchanging data with the application control module 3010 via wireless communication means such as Wi-Fi, Bluetooth and infrared devices, or code scanning and keyboard input. The module 3020 plays the role of switching the communication mode from one wireless communication mode such as internet communication with the service provider to other wireless communication modes such as Wi-Fi, Bluetooth and infrared, or code scanning and keyboard inputting with the application control module 3010 in the mobile phone (see FIG. 17).

Based on the above described systematic framework, there is provided information processing methods in accordance with an embodiment of the present invention as follows:

### 1. Card-Issuing Method

The card-issuing method is the procedure through which the card issuer issues a multi-application IC card to a user. The method comprises the following steps:

Step (a): the card-issuing module 100 generates the user ID according to the user's ID features, the generation method (such as ordinal numbers) as defined by the card issuer, and records the user ID in the database of the card issuer.

Step (b): The module 100 obtains the Master Key from the card issuer. This Master Key can either be inputted manually by the card issuer or generated by the computer system.

Step (c): The module 100 generates the user EKey and MKey through symmetric or asymmetric algorithm (Algorithm A) using the user ID in Step (a) and Master Key in Step (b) as parameters.

Step (d): The module 100 writes the user ID, EKey, MKey, the authentication and security management module 3000 and the multi-application data storage area 3001 into the multi-application IC card through an IC card read-write device in the card issuer device 10, where the writing process includes the initialization of counters in the module 3000.

### 2. Method Adopted by Service Provider to Write Service Token Information in User's IC Card

Only after the user has purchased products or services from a service provider by paying with the IC card provided by the card issuers (which are banks, in most cases), will the service provider be able to input its service token information into the user's ID card. The service provider also needs to have obtained permission from the card issuer. With this framework, the method for writing the service token into a user's IC card comprises the following steps:

Step (a): The service provider's service module 200 acquires the user ID and values in the counter from the authentication and security management module 3000 in the user's IC card via the application control module 3010 in the user's mobile phone, and upon successful authentication, the module 3000 sends the user ID and values in the counter to the module 200 via the module 3010.

Step (b): The module 200 acquires the service token information and the SKey generated for the specific user by the service provider from the service provider device 20.

Step (c): The module 200 submits the user ID, values in the counter and the service token information and SKey stated in Step (b) to the service provider management module 101 of the card issuer.

Step (d): After authentication, the module 101 generates the user's EKey and MKey using the obtained user ID, encrypts the SKey with Algorithm A1 using EKey and the values in the counter and generates the SID and a MAC check code to be sent to the module 200. The SID is generated according to SID features and the generation methods (such as ordinal numbers) are defined by the card issuer. The MAC check code is generated with Algorithm A2 using values in the counter, MKey, SID, encrypted SKey and service token information.

Step (e): The module 200 sends the service token information and encrypted SKey, SID and MAC check code to the module 3000 through the module 3010 in the mobile phone.

Step (f): The module 3000 in the IC card verifies information provided by service provider using the method specified as follows: The module 3000 processes the acquired service provider SID, service ID, encrypted S Key, MKey and values in the counter with Algorithm A2 and compares the result with the MAC check code sent from the module 200. If they are consistent, the encrypted SKey stated in Step (c) will be decrypted via Algorithm Al using the user's Ekey and values in the counter, and then input into the multi-application storage area 3001 together with SID and service token information in the canonical format of the authentication and security management module 3000. If they are inconsistent, the above information cannot be inputted into the user's IC card. The data between the module 101 and the module 200, between the module 200 and the module 3010 in the mobile phone, between the module 200 and the module 3020 and between the module 3020 and the module 3010 in the mobile phone is encrypted before transmission.

### 3. Method Adopted by Service Provider to Modify Service Token Information in User's IC Card

Only after the service provider has inputted its service token information into the user's IC card can they then modify the service token information. In such a case, the modification of service token information in the user's IC card only affects the user and the service provider and not the card issuer. The method for modifying the service token in the user's IC card comprises the following steps:

Step (a): The authentication and security management module 3000 of the user's IC card submits the user ID and values in the counter to the service provider's service module 200 via the application control module 3010 in the user's mobile phone.

Step (b): The module 200 generates the SKey with Algorithm S using the user ID and the service provider's Master Key as parameters, then obtains SID corresponding to the user ID from the database of the service provider.

Step (c): After acquiring the modified service token information from the service provider device 20, the module 200 generates a SMAC check code via Algorithm A2 using the SKey, SID, values in the counter and the modified service token information as parameters. The SMAC check code is then sent to the module 3000 through the module 3010 along with SID and the modified service token information.

Step (d): After receiving the SID, SMAC check code and the modified service token information, the module 3000 also generates a SMAC check code via Algorithm A2 using the SKey, SID, values in the counter and the modified service token information as parameters.

Step (e): The module 3000 compares the generated SMAC check code with the SMAC check code generated by the module 200; if the two check codes are identical, the service token information modified by service provider will be written into the corresponding data storage area in the multi-application data storage area 3001. Otherwise, the above information cannot be written into the user's IC card.

### 4. Method Adopted by Service Provider to Check or Inspect Service Token Information in User's IC Card

A method for inspecting the service token in the user's ID card comprises the follow steps:

Step (a): The authentication and security management module 3000 of the user's IC card submits the user ID and values in the counter to the service module 200 via the application control module 3010 in the user's mobile phone.

Step (b): The module 200 generates a SKey via Algorithm S by using the user ID and the service provider's Master Key as parameters and obtains the SID corresponding to the user ID from the database of the service provider.

Step (c): The module 200 generates a SMAC check code via Algorithm A2 using SKey, SID and values in the counter as parameters.

Step (d): The module 200 sends the SID and SMAC check code to the module 3000 through the module 3010.

Step (e): After receiving the SID and SMAC check code, the module 3000 also generates a SMAC check code via Algorithm A2 using SKey, SID and values in the counter as parameters.

Step (f): The module 3000 compares the generated SMAC check code with the check code received from the module 200; if they are identical, the service token corresponding to the SID will be sent to the module 200 via the module 3010 in the mobile phone. Otherwise, the module 3000 will not send the service token to the module 200.

### 5. Method Adopted by Service Provider to Delete Service Token Information in User's IC Card

A method for deleting the service token in the user's IC card comprises the following steps:

Step (a): The authentication and security management module 3000 of the user's IC card submits the user ID and values in the counter to the service module 200 via the application control module 3010 in the user's mobile phone.

Step (b): The module 200 generates an SKey via Algorithm S using the user ID and service provider's Master Key as parameters and obtains the SID corresponding to the user ID from the database of the service provider.

Step (c): The module 200 obtains the service provider flag bit representing the information deletion from the service provider device 10, thereafter it generates a SMAC check code via Algorithm A2 using the SKey, SID, values in the counter and the said service provider flag bit as parameters. The SMAC check code is then sent to the module 3000 via the module 3010 along with SID and the said service provider flag bit.

Step (d): After receiving the SID, SMAC check code and the information set as deleted by the service provider flag bit in the formatting of the service token, the module 3000 proceeds to generate a SMAC check code via Algorithm A2 using SKey, SID, values in the counter and such information as parameters.

Step (e): The module 3000 compares the generated SMAC check code with the SMAC check code received from the module 200; if they are identical, the information set as deleted by the flag bits of service provider will be inputted into the corresponding service provider flag bit in the format of the service token. Otherwise, the above information cannot be inputted into the user's IC card.

### 6. Method Adopted by User to Check or Inspect Service Token Information in the IC Card via Mobile Phone

A method for inspecting the service token in the user's IC card comprises the following steps:

Step (a): The user inputs PIN code into his/her mobile phone, and the application control management module 3010 in the mobile phone sends the PIN code to the authentication and security management module 3000 via NFC.

Step (b): The module 3000 verifies the PIN code inputted by the user.

Step (c): If the PIN code is correct, the module 3000 submits all service token information stored in the multi-application storage area 3001 to the module 3010. Otherwise, the module 3000 will not submit such information to the module 3010.

### 7. Method Adopted by User to Delete Service Token Information in Their IC Card via Mobile Phone

A method for deleting the service token in the user's IC card comprises the following steps:

Step (a): The user inputs PIN code into the mobile phone, and the application control management module 3010 in the mobile phone sends the PIN code to the authentication and security management module 3000 via NFC.

Step (b): The module 3000 verifies the PIN code inputted by the user.

Step (c): If the PIN code is correct, the module 3000 will retrieve the deletion information in the user flag bit selected by the user from the module 3010 and write the deletion information into the user flag bit in the format of the specified service token. Otherwise, the above information cannot be inputted into the user's IC card.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein. It is further to be understood that features from one or more of the described embodiments may be combined to form further embodiments.

We claim:

1. A multiple-application systematic framework for an IC card comprising:
(a) a card issuer device 10, the card issuer device 10 comprises a card-issuing module 100 and a service provider management module 101;
(b) a service provider device 20, the service provider device 20 comprises a service module 200;
(c) a user terminal device 30, the user terminal device 30 comprises an IC card 300 supplied by a card issuer and a communications device 301 comprising an application control module 3010, the IC card 300 comprises an authentication and security management module 3000 and a multi-application data storage area 3001;
wherein the card issuer device 10, the service provider device 20 and the user terminal device 30 interconnect via a first communications means and the communications device 301 and the IC card 300 communicate through a second communications means,
the service provider management module 101 enables the service module 200 to use storage space in the multi-application data storage area 3001 for providing a service to a user via a service token, and the service module 200 communicates with the application control module 3010 to enable a user and/or at least one service provider to manipulate one or more service tokens in the IC card 300.

2. The multiple-application systematic framework according claim 1, wherein manipulating one or more service tokens in the IC card 300 by the user and/or the service provider comprises generating, modifying, checking, inspecting or deleting one or more service tokens in the IC card 300.

3. The multiple-application systematic framework according to claim 1 or 2, wherein the card-issuing module 100 is operable to generate a unique identification (ID) for the IC card 300, store the unique ID in a database of the card issuer, generate encryption and decryption secret key (EKey) and verification secret key (MKey) for the IC card 300 and write into the IC card 300 the unique ID, EKey and MKey.

4. The multiple-application systematic framework according to claim 3, wherein the card-issuing module 100 is further operable to write the authentication and security management module 3000 and the multi-application data storage area 3001 into the IC card 300.

5. The multiple-application systematic framework according to any one of claims 2 to 4, wherein the unique ID of the IC card 300 is expressed in ordinal numbers or as the original card number of the IC card 300 or the account number of the user.

6. The multiple-application systematic framework according to any of claims 2 to 5, wherein the EKey and the MKey are generated through Algorithm A using a Master Key of the card issuer and the unique ID of the IC card 300 as parameters.

7. The multiple-application systematic framework according to claim 6, wherein the Algorithm A is a general symmetric or asymmetric algorithm and the Master Key is defined by the card issuer or generated by a computer system of the card issuer device 10.

8. The multiple-application systematic framework according to any of the preceding claims, wherein the service provider management module 101 is operable to allocate a unique service provider ID (SID) to the service provider, encrypt an information management secret key (SKey) provided by the service provider to the user and generate a MAC check code for the SID, encrypted SKey and service token to be written into the IC card 300 by the service provider.

9. The multiple-application systematic framework according to claim 8, wherein the SID, encrypted SKey and service token is written onto the IC card 300 upon verification of the MAC code.

10. The multiple-application systematic framework according to any of the preceding claims, wherein the service module 200 is operable to retrieve a user ID and values of the counter in the IC card 300, retrieve the service token and the SKey generated for the user from the service SKey generated for the user, and is further operable to obtain from the card issuer the encrypted SKey, SID and MAC check code.

11. The multiple-application systematic framework according to claim 10, wherein the service module 200 is further operable to record the user ID and the SID into a database of the service provider and to submit the encrypted SKey, SID, service ID and MAC check code to the user via the first communications means in a prescribed format.

12. The multiple-application systematic framework according to claim 10 or 11, wherein after the user has obtained the service token from the service provider, either party wishes to modify the service token, the service module 200 is operable to collect the user ID and values of the counter in the IC card 300 and the modified service token information from the service provider device 20.

13. The multiple-application systematic framework according to any of claims 10 to 12, wherein the service module 200 further operates to generate an SKey through Algorithm S using a Master Key of the service provider and the user ID as parameters, obtain from the database of the service provider the corresponding SID using the user ID and generate a SMAC check code through Algorithm A2 using the SKey, SID, values of the counter and modified service token information as parameters, and send the above to the user via the first communications means together with the SID and the modified service token.

14. The multiple-application systematic framework according to any of claims 10 to 13, wherein after the user has obtained the service token from the service provider, and the service provider wishes to inspect the relevant service token, the service module 200 operates to acquire the user ID and values in the counter of the user's IC card 300; the service module 200 also operates to generate an SKey through Algorithm S using the service provider's Master Key and the user ID as parameters, obtain from the database of the service provider the corresponding SID using the user ID and generate a SMAC check code through Algorithm A2 using the SKey, SID, values of the counter as parameters; and send the Skey, SID and SMAC check code to the user via the first communications means; the service module 200 is further operable to send the generated information to the service provider device 20 for inspection after verification and return by the user.

15. The multiple-application systematic framework according to any of claims 10 to 14, wherein after the user has obtained the service token from the service provider, the service provider wishes to delete the service token, the service module 200 operates to collect the user ID and values in the counter of the user's IC card 300 and retrieve from the service provider device 20 the flag bit that represents the information deletion; the module 200 also operates to generate an SKey through Algorithm S using the service provider's Master Key and the user ID as parameters, obtain from the database of the service provider the corresponding SID using the user ID and generate a SMAC check code through Algorithm A2 using the SKey, SID, values of the counter and the information set as deleted by the service provider flag bit in the formatting of the service token as parameters; and further operates to send the generated information to the user via the first communications means together with the SID and the information set as deleted by the service provider flag bit in the format of the service token.

16. The multiple-application systematic framework according to any of the preceding claims, wherein the authentication and security management module 3000 is a software program in the user's IC card 300 and operates to communicate with the application control module 3010 in the user's communications device 301 via the second communication means; conduct security authentication and encryption and decryption with the module 3010; receive control instructions of the card issuer, service provider or user transmitted by the module 3010 and read, write in, modify, check or delete data in the multi-application data storage area 3001; and to output data or calculation results to the module 3010.

17. The multiple-application systematic framework according to claim 16, wherein the security authentication and encryption and decryption operation are based on common symmetric or asymmetric algorithms.

18. The multiple-application systematic framework according to claim 17, wherein the authentication and operation processes involve ID, EKey, SID, MAC check code, SMAC check code, SKey and values in the counter.

19. The multiple-application systematic framework according to claim 18, wherein the values in the counter is a positive integer and increases by one after each participation in the authentication and encryption and decryption operation.

20. The multiple-application systematic framework according to any of claims 16 to 19, wherein when the service provider or user modifies the service token in the user's IC card 300 and after the authentication and security management module 3000 sends the user ID and values of the counter to the service module 200, the module 3000 operates to obtain from the module 200 the SID, SMAC check code and service token modified by the service provider via the application control module 3010; the module 3000 further operates to generate a SMAC check code through Algorithm A2 using values in the counter, SID, corresponding SKey and modified service token as parameters; such SMAC check code is compared to the existing SMAC check code; and the modified service token is written into the corresponding data storage area if the SMAC check code is correct.

21. The multiple-application systematic framework according to any of claims 16 to 20, wherein when the service provider checks the service token in the user's IC card 300, the authentication and security management module 3000 operates to send the user ID and values of the counter to the service module 200 and obtains in return the SID and SMAC check code from the module 200 via the application control module 3010; the module 3000 further operates to work out a SMAC check code through Algorithm A2 using values in the counter, SID and corresponding SKey as parameters and compare such SMAC check code with the existing SMAC check code; and proceeds to send the service token to the module 200 if the SMAC code is correct.

22. The multiple-application systematic framework according to any of claims 16 to 21, wherein when the service provider deletes the service token in the user's IC card 300 and after sending the user ID and values in the counter to the service module 200, the authentication and security management module 3000 operates to obtain the SID, SMAC check code and the information set as deleted by the service provider flag bit in the format of the service token from the module 200 via the application control module 3010; the module 3000 further operates to generate a SMAC check code through Algorithm A2 using values in the counter, SID, SKey corresponding to the SID and the information set as deleted by the service provider flag bit in the format of service token and compare such SMAC check code with the existing SMAC check code; and proceeds to write the corresponding flag bit in the format of the service token into the corresponding service provider flag bit in the format of the service token if the result is correct.

23. The multiple-application systematic framework according to any of claims 16 to 22, wherein when the user checks the service token in the IC card 300 via the communications device 301, the authentication and security management module 3000 operates to verify the user's PIN; and upon successful authentication, proceeds to send all service token(s) in the multi-application data storage area 3001 to the application control module 3010.

24. The multiple-application systematic framework according to any of claims 16 to 23, wherein when the user deletes the service token in the IC card 300 via the communications device 301, the authentication and security management module 3000 operates to verify the user's PIN; and upon successful authentication, proceeds to receive from the application control module 3010 the user flag bit that represents the information deletion selected by the user and write into the specified user flag bit in the format of the service token such deleted information.

25. The multiple-application systematic framework according to any of the preceding claims, wherein the multi-application data storage area 3001 is a unique storage space in the user's IC card 300 for storing one or more service tokens provided by at least one service provider, SID and SKey.

26. The multiple-application systematic framework according to claim 25, wherein the storage size of the multi-application storage area 3001 is set by the card issuer at the time of issuance of the IC card 300.

27. The multiple-application systemic framework according to any of the preceding claims, wherein the user terminal device 30 further comprises a communications device 302 comprising an application module 3020.

28. The multiple-application systematic framework according to claim 27, wherein the application control module 3010 is a software that operates in the communications device 301; and operates to communicate and exchange data with the service module 200 through the first communications means; exchanging data with the IC card 300 through the second communications means; exchanging data with the application module 3020 in the communications device 302 via a third communications means; and further operates to facilitate data exchange between the user and the service provider, the IC card 300 or the communications device 302 via mobile keyboard and display screen.

29. The multiple-application systematic framework according to claim 27 or 28, wherein the application module 3020 operates to communicate and exchange data with the service module 200 in the communications device 302 via the first communications means and further operates to exchange data with the application control module 3010 via the third communication means.

30. The multiple-application systematic framework according to claim 28 or 29, wherein the third communications means is one of wireless communication means and code scanning and keyboard input means.

31. The multiple-application systematic framework according to claim 30, wherein the wireless communication means is one of Wi-Fi, Bluetooth and infra-red.

32. The multiple-application systematic framework according to any of the preceding claims, wherein the first communications means is one of the Internet, intranet and any network suitable for interconnecting the card issuer device 10, the service provider device 20 and the user terminal device 30.

33. The multiple-application systematic framework according to any of the preceding claims, wherein the second communications means is a wireless communication means comprising Wi-Fi, Bluetooth, infra-red and near field communication (NFC).

34. A method for issuing a multiple-application IC card by a card issuer to a user according to any one of claims 6 to 33 comprising:
(a) generating the user ID according to the user's ID features, the generation method defined by the card issuer, and recording the user ID in the database of the card issuer by the card-issuing module 100;
(b) obtaining the Master Key from the card issuer by the module 100, where the Master Key is inputted manually by the card issuer or generated by the computer system;
(c) generating the user EKey and MKey through symmetric or asymmetric algorithm (Algorithm A) using the user ID in Step (a) and the Master Key in Step (b) as parameters by the module 100; and
(d) writing the user ID, EKey, MKey, the authentication and security management module 3000 and the multi-application data storage area 3001 into the IC card 300 by the module 100 through an IC card read-write device; where the writing process includes the initialization of counters in the module 3000.

35. A method for writing the service token into the user's IC card according to claim 34 comprising:
(a) acquiring the user ID and values in the counter from the authentication and security management module 3000 in the user's IC card 300 by the service module 200 via the application control module 3010 in the user's communications device 301; and upon successful authentication, sending the user ID and values in the counter to the module 200 by the module 3000 via the module 3010;
(b) acquiring the service token information and the SKey generated for the specific user by the service provider from the service provider device 20 by the module 200;
(c) submitting the user ID, values in the counter and the service token information and SKey in Step (b) to the service provider management module 101 of the card issuer by the module 200;
(d) generating, upon successful authentication, the user's EKey and MKey using the obtained user ID, encrypting the SKey with Algorithm A1 using EKey and the values in the counter and generating the SID and a MAC check code to be sent to the module 200 by the module 101; the SID is generated according to SID features and the generation methods are defined by the card issuer; where the MAC check code is generated with Algorithm A2 using values in the counter, MKey, SID, encrypted SKey and service token information;
(e) sending the service token information and encrypted SKey, SID and MAC check code to the module 3000 by the module 200 through the module 3010 in the communications device 301; and
(f) verifying information provided by the service provider by the module 3000.

36. The method for writing the service ID into the user's IC card according to claim 35 wherein the module 3000 verifies the information provided by service provider as follows:
processing the acquired service provider SID, service token, encrypted SKey, MKey and values in the counter with Algorithm A2 and comparing the result with the MAC check code sent from the module 200;
upon successful verification, decrypting the encrypted SKey via Algorithm A1 using the user's Ekey and values in the counter and inputting into the multi-application storage area 3001 together with the SID and the service token information in the prescribed format of the authentication and security management module 3000; transmitting the encrypted data between the module 101 and the module 200, between the module 200 and the module 3010, between the module 200 and the module 3020 and between the module 3020 and the module 3010.

37. A method for modifying the service token in the user's IC card according to claim 34 comprising:
(a) submitting the user ID and values in the counter to the service module 200 by the authentication and security management module 3000 of the user's IC card 300 via the application control module 3010 in the communications device 301; (b) generating the SKey with Algorithm S using the user ID and the service provider's Master Key as parameters by the module 200, and further obtaining SID corresponding to the user ID from the database of the service provider by the module 200;
(c) after acquiring the modified service token information from service provider device 20, further generating a SMAC check code via Algorithm A2 using the SKey, SID, values in the counter and the modified service token information as parameters, and sending the SMAC check code to the module 3000 through the module 3010 along with the SID and the modified service token information by the module 200;
(d) after receiving the SID, SMAC check code and the modified service token information, further generating a SMAC check code via Algorithm A2 using the SKey, SID, values in the counter and the modified service token information as parameters by the module 3000; and
(e) comparing the generated SMAC check code with the one received from the module 200 by the module 3000; if the two are identical, the service token information modified by the service provider will be written into the corresponding data storage area in the multi-application data storage area 3001.

38. A method for inspecting the service token in the user's IC card according to claim 34 comprising:
(a) submitting the user ID and values in the counter to the service module 200 by the authentication and security management module 3000 of user's IC card 300 via the application control module 3010 in the user's communications device 301;
(b) generating a SKey via Algorithm S using the user ID and the service provider's Master Key as parameters and obtaining the SID corresponding to the user ID from the database of the service provider by the module 200;
(c) generating a SMAC check code via Algorithm A2 using the SKey, SID and values in the counter as parameters by the module 200;
(d) sending the SID and SMAC check code to the module 3000 by the module 200 through the module 3010;
(e) after receiving the SID and SMAC check code, generating a SMAC check code via Algorithm A2 using the SKey, SID and values in the counter as parameters by the module 3000; and (f) comparing the generated SMAC check code with the one received from the module 200 by the module 3000; if they are identical, the service token corresponding to the SID will be sent to the module 200 via the module 3010 in the communications device 301.

39. A method for deleting the service token in the user's IC card according to claim 34 comprising:
(a) submitting the user ID and values in the counter to the service module 200 by the authentication and security management module 3000 of the user's IC card 300 via the application control module 3010 in the user's communication device 301;
(b) generating a SKey via Algorithm S using the user ID and service provider's Master Key as parameters and obtaining the SID corresponding to the user ID from the database of the service provider by the module 200;
(c) obtaining the service provider flag bit representing the information deletion from the service provider device 20, generating a SMAC check code via Algorithm A2 using the SKey, SID, values in the counter and the said service provider flag bit as parameters by the module 200; sending the SMAC check code to the module 3000 via the module 3010 along with SID and the said service provider flag bit;
(d) after receiving the SID, SMAC check code and the information set as deleted by the service provider flag bit in the formatting of the service format, generating a SMAC check code via Algorithm A2 using the SKey, SID, values in counter and such information as parameters by the module 3000; and
(e) comparing the generated SMAC check code with the check code received from the module 200; deleting the information set as deleted by the flag bits of the service provider if they are identical; and inputting the information into the corresponding service provider flag bit in the format of the service token by the module 3000.

40. A method for inspecting the service token in the user's IC card according to claim 34 comprising:
(a) user inputting PIN code into the communications device 301, and the application control management module 3010 in the communications device 301 sending the PIN code to the authentication and security management module 3000 via the second communications means;
(b) verifying the PIN code inputted by the user by the module 3000; and
(c) if the PIN code is correct, submitting all service token information stored in the multi-application storage area 3001 to the module 3010 by the module 3000.

41. A method for deleting the service token in the user's IC card according to claim 34 comprising:
(a) user inputting PIN code into the communications device 301, and the application control management module 3010 in the communications device 301 sending the PIN code to the authentication and security management Module 3000 via the second communications means;
(b) verifying the PIN code inputted by the user by the module 3000; and
(c) if the PIN code is correct, obtaining the deletion information in the user flag bit selected by the user from the module 3010 and writing the deletion information into the user flag bit in the format of the specified service token by the module 3000.
